(19) United States
(12) Patent Application Publication
(10) Pub. No.: US 2012/0114866 A1
(43) Pub. Date: May 10, 2012

(54) METHOD FOR APPLYING A FLUID ONTO A SUBSTRATE

(75) Inventor: Wolf Rüdiger Huck, Gockhausen (CH)

(73) Assignee: SIKA TECHNOLOGY AG, BAAR (CH)

(21) Appl. No.: 13/383,107

(22) PCT Filed: Jul. 8, 2010
(86) PCT No.: PCT/EP2010/059789

§ 371 Date: Jan. 9, 2012

(30) Foreign Application Priority Data
Jul. 8, 2009 (EP) 09164945.9

(51) Int. Cl. B05D 1/28; B05C 21/00

(52) U.S. Cl. 427/429; 401/196; 118/264

(57) ABSTRACT

A method for applying a fluid onto a substrate. The fluid, upon exiting a container, passes through a porous material that is in contact with the substrate, and the porous material is provided with a marking agent that marks the application site of the fluid on the substrate.

### BACKGROUND

The invention lies in the field of application technology and relates to the application of fluids onto substrates, wherein the application site of the fluid is marked on the substrate or, respectively, is made visible or detectable.

The accurate application of fluids onto substrates plays an important role in the sector of pretreatment agents for bonding surfaces. Problematic, in particular, is the application of clear and colorless fluids as a pretreatment agent because after the application, the application site is often difficult to identify and in most cases invisible to the eye. However, in order to ensure on the substrate a proper bonding of an adhesive, sealant or a coating, the latter have to be applied onto the pretreated site.

A common approach to make a fluid visible on a substrate is to add a dye to the fluid. In the sector of pretreatment agents for bonding surfaces, the use of luminescent substances is also known. For example, pretreatment agents containing luminescent agents are known from WO 03/106579 A1.

A disadvantage of using dyes or luminescent substances in pretreatment agents is their frequently observed incompatibility with adhesion-promoting constituents in the pretreatment agent, whereby the storage stability of the pretreatment agent can be greatly impaired. In some cases, this incompatibility can even result in precipitations of substances from the pretreatment agent which, on the one hand, can damage the applicator and, on the other, can also result in degradation of the quality of the adhesive bond.

These disadvantages occur in particular in the case of aqueous pretreatment agents that contain luminescent substances as a marking agent. In order to establish the water solubility of luminescent substances, they are in particular often provided with hydrophilic groups, for example with sulfate groups. Luminescent substances modified in such a manner are particularly highly incompatible with the adhesion promoters typically used in pretreatment agents, in particular with aminosilanes or mercaptosilanes.

### SUMMARY

It is therefore desirable to provide a method for applying a fluid onto a substrate that makes the application site of the fluid visible, but does not impair said fluid and in particular its storage stability in any way.

This may be achieved by a method for applying a fluid onto a substrate according to the features of an exemplary embodiment.

An advantage of embodiments is that the marking agent, which marks the application site of the fluid on the substrate, is not contained already in the fluid during the storage of the same, but is used only upon the application of said fluid. Thereby, it is possible to avoid negative effects of the marking agent on the storage stability of the fluid.

Another advantage of embodiments is that the duration of use of the porous material on the applicator can be checked. If, in particular, the marking agent is no longer applied onto the substrate during the application of the fluid, the applicator should be changed or the porous material should be replaced.

Furthermore, it was found to be particularly advantageous that the application site of fluids applied in accordance with embodiments is still visible even after wiping off the fluid with a sponge, towel or other fiber materials. Due to the difficult dosing of pretreatment agents in very thin layers, a wipe off step after the application is quite common.

Further aspects of the invention are exemplified in additional embodiments.

### BRIEF DESCRIPTION OF THE DRAWINGS

In the following, exemplary embodiments of the invention are explained in more detail by means of the drawings. Identical or identically functioning elements are indicated in the different figures with the same reference numbers.

In the figures:

FIG. 1 shows a schematic illustration of an applicator and the application of a fluid onto a substrate;

FIG. 2 shows a schematic illustration of an applicator;

FIG. 3 shows a schematic illustration of an applicator;

FIG. 4 shows a schematic illustration of a portion of an applicator;

FIG. 5 shows a schematic illustration of an applicator with laterally attached cartridges;

FIG. 6 shows a schematic bottom view onto the porous material of the applicator from FIG. 5;

FIG. 7 shows a schematic bottom view onto the porous material of an applicator;

FIG. 8 shows a schematic illustration of an applicator from FIG. 5 and the application of a fluid onto a substrate;

FIG. 9 shows a schematic illustration of an applicator, wherein container and porous material are connected with a hose.

Shown are only the elements that are essential for the immediate understanding of embodiments. Of course, the invention is not limited to the shown and described exemplary embodiments.

### DETAILED DESCRIPTION OF EMBODIMENTS

The present invention relates to a method for applying a fluid onto a substrate, wherein the fluid upon exiting a container passes through a porous material that is in contact with the substrate. The porous material is provided with a marking agent that marks the application site of the fluid on the substrate.

The fluid may be a clear, colorless fluid. The fluid can be aqueous but can also be based on an organic solvent. In embodiments, it is an aqueous fluid. Such fluids have in particular the disadvantage that, depending on the nature of the substrate, their application site is difficult to identify. This is particularly problematic if a further substance is to be applied onto the application site of the fluid. This is the case, for example, if the fluid is a pretreatment agent for bonding surfaces which, for example in preparation for adhesion, is applied onto the later application site of the adhesive.

Accordingly, said fluid may be a pretreatment agent for adhesives, sealants or coatings. Said fluid may be an activator. Activators are typically solvents that contain adhesion-promoting compounds.

The fluid may be a pretreatment agent that contains a mercaptosilane and/or aminosilane and/or their reaction products, such as an aminosilane. Said fluid may be an aqueous activator comprising at least one mercaptosilane and/or one aminosilane.

In the present disclosure, the terms “aminosilane” and “mercaptosilane” designate compounds which, on the one hand, have at least one, usually two or three alkoxy groups or acyloxy groups directly bound via Si—O bonds to the silicon atom and, on the other, at least one amino group or mercapto group directly bound via a Si—C bond to the silicon atom.

For example, suitable aminosilanes are 3-minopropyltrimethoxysilane, N-(2-aminoethyl)-3-aminopropyltrimethoxysilane, Bis[3-(trimethoxylsilyl)-propyl]-amine, 3-aminopropyltriethoxysilane, N-(2-aminoethyl)-3-aminopropyltriethoxysilane or Bis[3-(triethoxysilyl)-propyl]-amine. Suitable mercaptosilanes are, for example, 3-mercaptopropyltriethoxysilane, 3-mercaptopropyltrimethoxysilane or 3-mercaptopropylmethyldimethosxysilane.

In embodiments, the marking agent may be placed in or on the porous material. In particular, the marking agent may be adsorbed on the porous material. The marking agent can be distributed over the entire porous material or the porous material can be only partially provided with the marking agent.

When applying the fluid onto the substrate, said fluid passes through the porous material and transports the marking agent out of the porous material so that the marking agent together with the fluid is deposited or applied onto the substrate. Here, the marking agent can be absorbed in any form by the fluid, for example in dissolved form or undissolved form, for example as a suspension or emulsion. It is important here that the marking agent is deposited onto the substrate during the entire duration of the application. The marking agent should not be completely used up in the case of very small fluid volumes passing through the porous material. However, there should be enough marking agent being transported onto the substrate so that the application site of the fluid is clearly visible.

The marking agent may be a substance that is at least partially soluble in the fluid to be applied. Thereby, the marking agent dissolves in the fluid that passes the porous material and is deposited on the substrate. The solubility and the dissolution process may be set here in such a manner that the marking agent is continuously dissolved by the fluid so that the fluid deposits an approximately constant proportion of marking agent onto the substrate.

Thus, the above-described method concerns a method in which the fluid, when passing through the porous material, continuously dissolves the marking agent from the porous material and deposits it onto the surface of the substrate.

For embodiments, any marking agent can be used as a marking agent that is suitable to mark the application site of the fluid on the substrate. For example, the marking agent can be a dye. The marking agent can be soluble and also insoluble, thus, can be a pigment, for example. The marking agent may be a luminescent substance.

Furthermore, the marking agent may involve an at least partially water-soluble substance. The marking agent may be a water-soluble, luminescent substance.

Accordingly, said fluid may be an aqueous fluid.

If the marking agent is a luminescent substance, detecting the application site of the fluid on the substrate takes place with devices and methods suitable for this, as they are well known to the person skilled in the art.

In embodiments, the marking agent may involve a substance that is substantially insoluble in the fluid to be applied, wherein said substance may be arranged as a cartridge at least in one location in the porous material or directly at the edge of the porous material and is in contact with the substrate.

Analogous to a conventional felt-tip marker, said cartridge can be made from a fiber material, such as a felt that may be saturated with the marking agent. Furthermore, the cartridge can be made from a solid marking agent that leaves a mark on the substrate due to abrasion similar to lead pencils or colored pencils, for example. Furthermore, said cartridge can also consist of a reservoir containing the liquid marking agent and a device for applying the marking agent onto the substrate, thus, for example, an enclosed rolling ball or a fiber material similar to ball pens, for example.

The porous material may be of such a nature that the fluid can pass therethrough. Through the size and the structure of the pores, the velocity with which the fluid passes through the porous material, and thus the application speed and amount can be adjusted in wide ranges. In particular, the porous material is an absorbent, porous material.

Said porous material involves preferably a sponge or a fiber material, in particular a felt or a fabric.

Embodiments further relate to a porous material on which a marking agent is adsorbed. The porous material and the marking agent are of the type as described above.

Fabricating such a porous material with the marking agent adsorbed thereon may be carried out by dipping the porous material into a solution of the marking agent or by dripping the marking agent onto the porous material and subsequently drying the porous material. For a better wetting of the porous material, the same can alternatively contain a wetting agent.

Embodiments further relate to an applicator for applying a fluid onto a substrate, the applicator comprising a container for the fluid with an outlet opening at which a porous material provided with a marking agent is attached.

The container that contains the fluid involves, for example, a bottle-like container, which can have any desired shape and is made of a material that is suitable for this purpose, such as plastic, glass or metal. This container may have an outlet opening or a region with a plurality of outlet openings through which the fluid gets from the container to the porous material.

Furthermore, the container can be of such a nature that it has an outer shell that is open opposite the outlet opening to the porous material and also an inner shell in which the fluid is contained. By pressing the outer shell, for example, the inner shell can be cracked so that the fluid emerges and flows through the outlet opening into the porous material. In such an embodiment, the outer shell may be made from a dimensionally stable but partially flexible plastic. The inner shell is in particular a glass ampoule. This embodiment is particularly suitable for disposable applicators.

The porous material can be secured on the container in any desired way. For example, said material can be secured by fasteners such as clips, clamps, grooves, threads, snap-fasteners and the like, or it can be adhered to the container. The porous material can be connected to the container in a reversible manner, whereby it can be replaced as required. Replacing the porous material is in particular needed once the porous material contains no marking agent anymore and therefore the application site of the fluid is no longer marked on the substrate.

The applicator can be a disposable or a reusable applicator.

Furthermore, the applicator can also be configured such that the container is connected to the porous material via a feed line, such as a hose.

Furthermore, the applicator can have a device that prevents the fluid from discharging. This can be, for example, a closure that is situated in the region of the outlet opening of the container and can be opened and/or closed. Another possibility of closing the applicator is a cover or the like that closes the applicator above the porous material.

It is a significant advantage of embodiments that during storage of an applicator, the marking agent is kept separately from the fluid to be applied. Due to the fact that no chemical reaction between the marking agent and the fluid takes place, this results in an improved storage stability of the entire application system.

Another important advantage of embodiments is that the quality of the porous material can be monitored by means of the marking on the substrate. Thus, besides its function as a marking agent, the marking agent that is preferably adsorbed on the porous material can serve for checking the duration of use of the porous material. In particular, if only little or no marking agent is deposited on the substrate, this indicates that the porous material has already been used for an extended period and should be replaced.

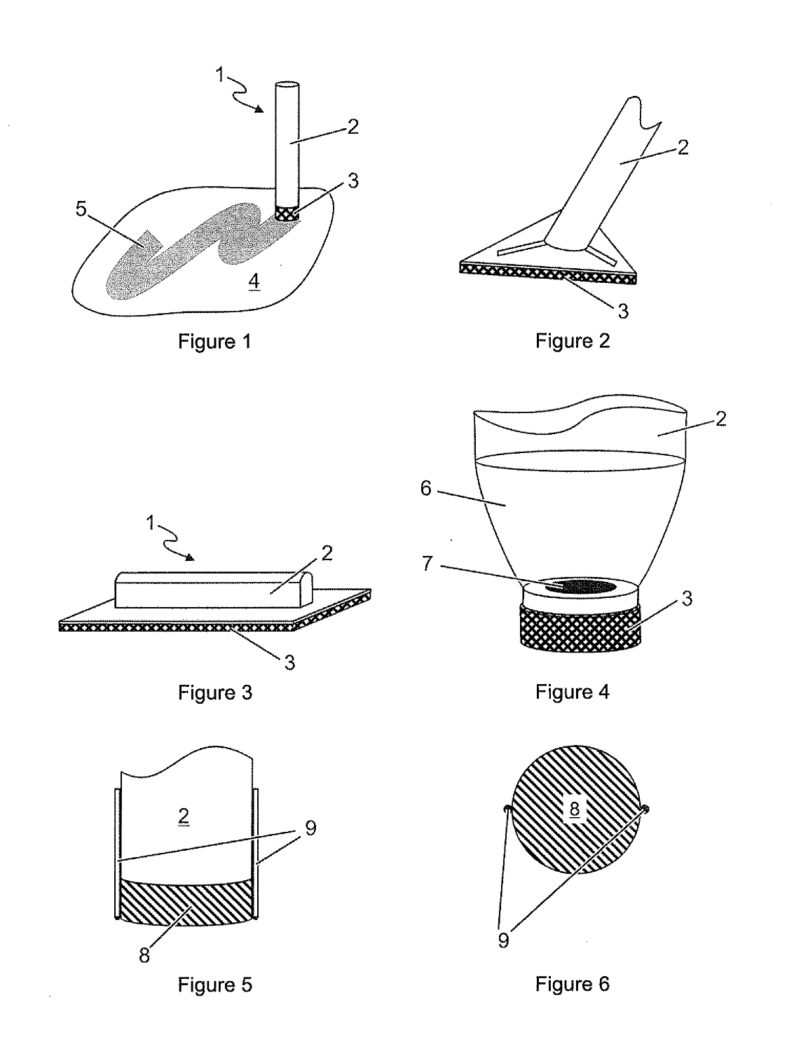

FIG. 1 shows an applicator 1 consisting of a container 2 in which the fluid to be applied is contained, and of a porous material 3 that is provided with a marking agent. The applicator is positioned such that the fluid flows out of an outlet opening and passes through the porous material that is in contact with the substrate 4 and thus is applied onto the substrate. When passing through the porous material, the fluid transports the marking agent out of said material and deposits it on the application site 5.

FIG. 2 shows a portion of an embodiment of an applicator that has the same function as the embodiment of FIG. 1, and, due to its geometry, is particularly suitable for applying fluids on substrates having angled surfaces and edges.

FIG. 3 shows an embodiment of an applicator 1 that has the same functionality as the embodiment of FIG. 1, and is particularly suitable for applying fluids on large areas. Applicators as illustrated in FIG. 3 are in particular used for single-use applications.

FIG. 4 shows a portion of an applicator with the same functionality as the embodiment of FIG. 1, wherein the fluid is illustrated that flows through the outlet opening 7 into the porous material 3.

FIG. 5 shows a portion of an alternative embodiment of an applicator having a container 2, in which the fluid to be applied is contained, and a porous material 8. In this embodiment, the marking agent is a substance that is insoluble in the fluid to be applied and that is arranged in the form of cartridges 9 directly at the edge of the porous material. Besides the cartridges 9, the porous material has no additional marking agent.

The cartridges 9 can be attached on the applicator in any desired manner; however, they are attached with respect to the porous material in such a manner that they are in contact with the substrate during the application and mark the application site of the fluid on the substrate.

FIG. 6 shows a bottom view of the porous material 8 and the marking agent or, respectively, the cartridges 9 of an applicator as illustrated in FIG. 5.

FIG. 7 shows a bottom view of a porous material 8 of an applicator, wherein the marking agent is placed at selected points in the porous material. This is carried out in that cartridges 9 of the insoluble marking agent in the fluid to be applied are inserted into the porous material so that their ends are flush with the surface of the porous material that is in contact with the substrate during the application.

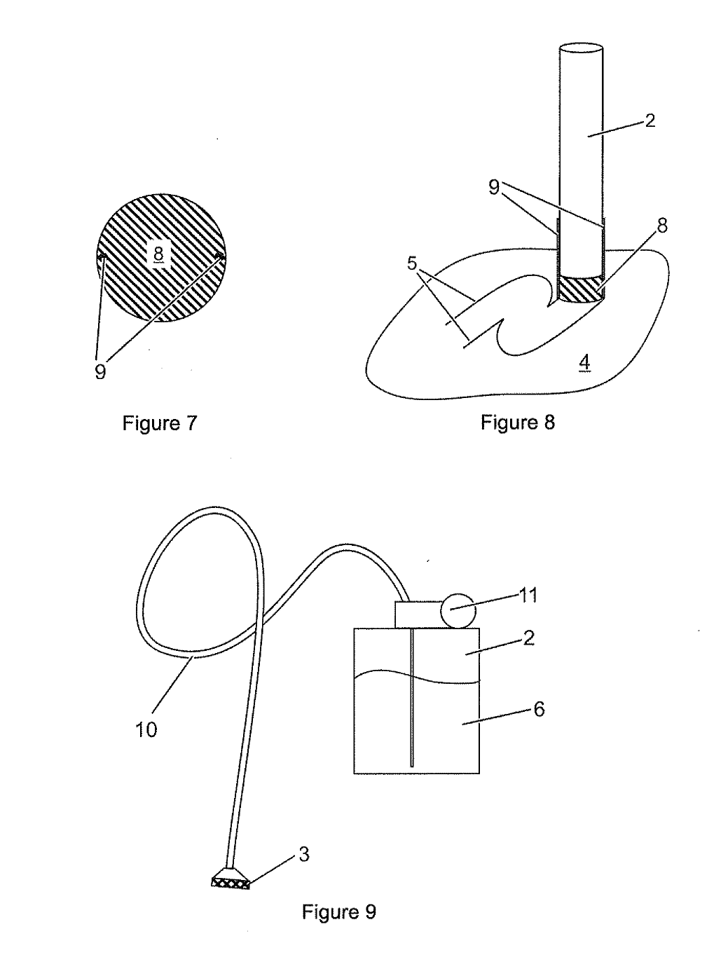

FIG. 8 shows an applicator 1 having a container 2, in which the fluid to be applied is contained, and a porous material 8, wherein the marking agent is placed at selected points in the porous material. The applicator is positioned such that the fluid flows out of an outlet opening through the porous material that is in contact with the substrate 4, and thus is applied onto the substrate. When applying the fluid, the marking agent attached in the form of cartridges 9 on the applicator comes into contact with the substrate at the same time as the porous material, and thus marks the boundary of the application site 5.

FIG. 9 shows an applicator wherein the container 2 containing the fluid 6 to be applied is connected via a hose 10 to the porous material 3. The fluid is delivered by means of a pump 11 through the hose to the porous material and the application site.

### EXAMPLES

In the following, exemplary embodiments are outlined that are intended to illustrate the described invention in more detail. Of course, the invention is not limited to these described exemplary embodiments.

A solution of 50% by weight of Leucophor® FTS LIQ, commercially available from Clariant AG, Switzerland, was prepared in 50% by weight of isopropanol. 1 to 4 drops each of approximately 0.4 g of the prepared solution were put onto a felt cylinder (medium hard, hydrophilized felt; diameter 20 mm, height 15 mm; commercially available from Filzfabrik Fulda GmbH & Co. KG, Germany). Subsequently, the felt cylinder was air dried in the dark for two weeks.

Then, the dried felt cylinder was secured by means of plastic felt holders on a 50 ml polyethylene bottle containing a pretreatment agent.

As a pretreatment agent, a mixture of 0.5% by weight 3-mercaptopropyltrimethoxysilane (Silquest® A-189 from Momentive Performance Materials Inc. USA), 0.5% by weight of 3-aminopropyltrimethoxysilane (Silquest® A-1110 from Momentive Performance Materials Inc., USA), 0.25% by weight of methyltrimethoxysilane (Fluka Chemie GmbH, Switzerland), 0.5% by weight of wetting agent (Tergitol® TMN-6 from Dow Chemical Company, USA), 1% by weight of acetic acid and 97.25% by weight of water (deionized) was used.

The pretreatment agent was subsequently applied onto a substrate (glass). The application site of the pretreatment agent could be detected by means of an UV lamp immediately after the application and also after the drying of the application site.

In a further test, after the application of the pretreatment agent, the application site was wiped off once with a dry paper towel. The application site could be detected by means of an UV lamp even after being wiped off.

Furthermore, 1% by weight of Leucophor® FTS LIQ was dissolved in the above-described pretreatment agent. After one to two days, white-yellowish flaky precipitations could be observed in the fluid.

1. A method for applying a fluid onto a substrate, wherein
the fluid upon exiting a container passes through a porous material that is in contact with the substrate, and
the porous material is provided with a marking agent that marks the application site of the fluid on the substrate.

2. The method according to claim 1, wherein the fluid is a clear colorless fluid.

3. The method according to claim 1, wherein the fluid is an aqueous fluid.

4. The method according to claim 1, wherein the fluid is a pretreatment agent for adhesives, sealants or coatings.

5. The method according to claim 4, wherein the pretreatment agent contains at least one of an aminosilane, a mercaptosilane, and the reaction product thereof.

6. The method according to claim 1, wherein the marking agent is a substance that is at least partially dissolvable in the fluid to be applied.

7. The method according to claim 1, wherein the marking agent is adsorbed on the porous material.

8. The method according to claim 1, wherein the marking agent is a luminescent substance.

9. The method according to claim 1, wherein when passing through the porous material, the fluid continuously dissolves the marking agent from the porous material and deposits it onto the surface of the substrate.

10. The method according to claim 1, wherein the marking agent is a water-soluble substance.

11. The method according to claim 1, wherein the marking agent is a substance that is insoluble in the fluid to be applied and that is arranged as a cartridge at least in one location in the porous material or directly at the edge of the porous material, and is in contact with the substrate.

12. The method according to claim 1, wherein the porous material is a sponge or a fiber material.

13. A porous material, wherein a marking agent is adsorbed thereon.

14. An applicator for applying a fluid onto a substrate, comprising a container for the fluid having an outlet opening at which a porous material provided with a marking agent is attached.
